(19) United States
(12) Patent Application Publication
(10) Pub. No.: US 2007/0260008 A1
(43) Pub. Date: Nov. 8, 2007

(54) Silica-Containing Silicone Resin Composition and Its Molded Product

(76) Inventors: Takashi Saito, Chiba (JP); Masayoshi Isozaki, Chiba (JP); Hideki Ando, Chiba (JP); Akiko Yamasaki, Chiba (JP)

Correspondence Address: BIRCH STEWART KOLASCH & BIRCH, PO BOX 747, FALLS CHURCH, VA, 22040-0747, US

(21) Appl. No.: 11/662,596

(22) PCT Filed: Sep. 21, 2005
(86) PCT No.: PCT/JP05/17368

§ 371 Date: Mar. 13, 2007

(51) Int. Cl. C08L 43/04

(52) U.S. Cl. 524/547

(57) ABSTRACT

The present invention relates to a silica-containing silicone resin composition which provides high heat resistance, high transparency, and high dimension stability, and thus can be suitably used for optical applications such as a lens, an optical disc, an optical fiber, and a substrate for a flat panel display, or for a window material for an automobile and the like. The silica-containing silicone resin composition is obtained by incorporating 1 to 70 wt % of silica fine particles in a silicone resin composition, which is formulated with a cage type silicone resin mainly constituted of a polyorganosilsesquioxane represented by [RSiO_{3/2}]ₙ (where R is an organic functional group containing a (meth)acryloyl group and n is 8, 10, or 12), and containing a cage type structure in its constitutional unit; and an unsaturated compound containing at least one unsaturated group represented by —R³—CR⁴═CH₂ or —CR⁴═CH₂, (where R³ represents an alkylene group, an alkylidene group, or a —OCO— group, and R⁴ represents hydrogen or an alkyl group in a molecule), and capable of undergoing radical copolymerization with the silicone resin at a weight ratio of 1:99 to 99:1.

### TECHNICAL FIELD

This invention relates to a silica-containing silicone resin composition and a three-dimensional crosslinked resin article molded therefrom.

### BACKGROUND ART

Inorganic glasses have high transparency, heat-resistance and dimension stability, and on account of those physical properties, they have been used from old days in a wide variety of industrial fields as structures which divide the space while transmitting visible light without obstructing the visibility. In spite of such excellent physical properties, inorganic glasses have two grave shortcomings; first, they are heavy with the specific gravity of 2.5 or more, and second, they have poor impact resistance and fracture easily. In recent years, as a result of progress of downsizing such as reduction in weight and thickness of the products in all kinds of industrial fields, there is an increasingly stronger demand from the users for improving the aforementioned shortcomings.

Transparent thermoplastics and transparent thermosetting plastics are expected as materials that meet the demand of the industries. Transparent thermoplastics are exemplified by polymethyl methacrylate (PMMA) and polycarbonate (PC). Of those transparent thermoplastics, PMMA is also called organic glass and is highly transparent, and is drawing attention as a material which has overcome the two shortcomings of glasses. However, those transparent plastics are markedly inferior to inorganic glasses in heat resistance and coefficient of linear thermal expansion, and face a problem of limited usage.

On the other hand, transparent thermosetting plastics are exemplified by epoxy resins, curable (meth)acrylic resins, and silicone resins, and they generally show higher heat resistance than the aforementioned thermoplastics. Of the transparent thermosetting plastics, epoxy resins show a small coefficient of curing shrinkage and excellent moldability, but have a shortcoming of low impact resistance and brittleness. Curable (meth)acrylic resins are well balanced in heat resistance, moldability, and physical properties of molded articles, but have shortcomings of large changes in dimension by water absorption and in coefficient of linear expansion by heat.

Of the thermosetting plastics, silicone resins are superior to other thermosets in heat resistance, weatherability, and water resistance and are materials having high potentialities of solving the above-mentioned problems associated with plastics and serving as substitutes for inorganic glasses. In particular, polyorganosilsesquioxanes of a ladder structure are known to show heat resistance comparable to that of polyimides.

The present invention has the following related documents.

Patent Document 1: JP 40-15989 B

Patent Document 2: JP 50-139900 A

Patent Document 3: JP 2003-137944 A

Patent Document 4: JP 2004-12396 A

Patent Document 5: JP 2004-143449 A

Non-Patent Document 1: J. Polymer Sci., Part C, No. 1, PP. 83-97 (1963)

Non-Patent Document 2: Journal of the Chemical Society of Japan, 571-580 (1998)

One example of the polyorganosilsesquioxanes is prepared as follows according to methods disclosed in Patent Documents 1 and 2 and Non-Patent Document 1: phenyltrichlorosilane is hydrolyzed to phenyltrihydroxysilane in an organic solvent, the hydrolysis product is heated in a water-free solvent in the presence of an alkaline rearrangement and condensation catalyst to give cage type octaphenylsilsesquioxane and the cage type octaphenylsilsesquioxane is separated and then heated and polymerized again in the presence of an alkaline rearrangement and condensation catalyst to give a phenylsiloxane prepolymer with low intrinsic viscosity; or the prepolymer is further heated and polymerized in the presence of an alkaline rearrangement and condensation catalyst to give a phenylsilsesquioxane polymer with high intrinsic viscosity.

However, the siloxane linkage in silicone resins further including the polyorganosilsesquioxanes prepared in the above-mentioned manner is highly flexible, so it is necessary to increase the crosslinking density in order to develop modulus required for structures. However, increasing the crosslinking density is undesirable as it markedly increases the coefficient of curing shrinkage, thereby rendering molded articles brittle. Further, the curing shrinkage increases the residual stress and this makes it extremely difficult to obtain thick-walled molded articles. For this reason, silicone resins with a high crosslinking density are limited to coating applications, and at the present, only silicone rubbers with a low crosslinking density are used in molding applications. A method of copolymerizing silicone resins with acrylic resins of good moldability is disclosed in, for example, Non-patent Document 2. According to this method, an acrylic polymer having alkoxysilyl side chains is used as a nonladder type silicone resin, and it is copolymerized with an alkoxysilane to form a hybrid consisting of an acrylic polymer as organic ingredient and a polysiloxane as inorganic ingredient. However, silicone resins intrinsically show poor compatibility with acrylic resins, and in many cases, the optical properties, particularly light transmittance, are damaged even when there is no problem with mechanical strength.

A silicone resin composition and a silicone resin molded article of a silanol-free silicone resin disclosed in Non-patent Documents 3 and 4 show excellent heat resistance, optical properties, and water absorption properties. However, a silicone resin prepared from a cage type polyorganosilsesquioxane and a disiloxane containing a reactive functional group by equilibration reaction in the presence of an alkaline rearrangement and condensation catalyst has a small number of reactive functional groups, 1.1 on the average, in the molecule, and is assumed to participate little in the three-dimensional crosslinked structure in the molded article. That is, increasing the proportion of silicone resin which contributes to characteristics such as heat resistance, weatherability, and water resistance decreases the absolute number of reactive functional groups in the molded article, and this in turn decreases the crosslinking density and hinders satisfactory construction of a three-dimensional crosslinked structure. As a result, the molded article shows deterioration in heat resistance and mechanical properties.

On the other hand, according to a method of reducing coefficient of linear thermal expansion, in general, there is provided a method of increasing a ratio of an inorganic component in a resin by adding an inorganic filler into the resin. However, in the case of adding the inorganic filler, there are problems that transparency of a molded article is lost, an inside of the resin becomes uneven due to poor dispersibility, and the like. JP 5-209027 A, JP 10-231339 A, and JP 10-298252 A disclose cured compositions which are prepared by uniformly dispersing colloidal silica in a radical polymerizable vinyl compound such as methyl methacrylate using a silane compound and which have excellent transparency and rigidity. However, those cured compositions are designed mainly for use in hard coating and cannot be suitably used as glass substitute materials. Further, composite cured materials formed of alicyclic (meth)acrylate, a silica fine particle, a silane compound, and a tertiary amine compound, which are disclosed in JP 2003-213067 A, maintain transparency and have excellent low linear expansivity. However, it is necessary that silica fine particles be added in an amount of 70 wt % or more with respect to alicyclic acylate to reduce a coefficient of linear thermal expansion to less than 40 ppm/K and a large amount of silica fine particles be uniformly dispersed. Also, viscosity of a composition increases because of a large amount of silica fine particles and it is difficult to produce a molded article.

Incidentally, the cage type polyorganosilsesquioxane represented by (RSiO_{3/2})ₙ has been known in Patent Document 5, and it is also described in the document that the cage type polyorganosilsesquioxane can be used combination with another resin. Here, R represents an organic functional group containing an acryloyl group and the like, and n is an integer of 8, 10, 12, or 14.

### DISCLOSURE OF THE INVENTION

### Problems to be solved by the Invention

Accordingly, an object of the present invention is to provide a silica-containing silicone resin composition capable of retaining physical properties such as optical properties of transparency and the like, heat resistance, and weatherability which silicone resins originally have and giving a silica-containing silicone resin molded article excellent in dimension stability (low linear thermal expansivity) by only mixing a small amount of silica fine particles.

### MEANS FOR SOLVING THE PROBLEMS

The inventors of the present invention have made extensive studies to attain the aforementioned object, found that a transparent silica-containing resin molded article excellent in low thermal expansivity and transparency and used suitably as a substitute for inorganic glasses can be prepared by mixing silica fine particles with an unsaturated compound which is capable of undergoing radical copolymerization and a cage type silicone resin at a specific ratio, and completed the present invention.

The present invention relates to a silica-containing silicone resin composition, characterized by containing 1 to 70 wt % of silica fine particles treated with a silane compound in a silicone resin composition, which is formulated with a cage type silicone resin mainly constituted of a polyorganosilsesquioxane represented by the general formula (1)
[RSiO_{3/2}]ₙ (1)

(where R is an organic functional group containing a (meth)acryloyl group, and n is 8, 10, or 12), and having a cage type structure in its constitutional unit; and

an unsaturated compound containing at least one unsaturated group represented by —R³—CR⁴═CH₂ or —CR⁴═CH₂, where R³ represents an alkylene group, an alkylidene group, or a —OCO— group, and R⁴ represents hydrogen or an alkyl group in a molecule, and capable of undergoing radical copolymerization with the silicone resin at a weight ratio of 1:99 to 99:1.

The silicone resin used here is preferably prepared by subjecting a silicone compound represented by the general formula (3)
RSiX₃ (3)
(where R is an organic functional group containing a (meth)acryloyl group and X represents a hydrolyzable group) to hydrolysis and partial condensation in the presence of a polar solvent and a basic catalyst, and further by subjecting the obtained hydrolysis product to recondensation in the presence of a nonopolar solvent and a basic catalyst. The silicone resin preferably has a cage type structure containing the same number of silicone atoms and (meth)acryloyl groups in the molecule.

An unsaturated compound which is capable of undergoing radical copolymerization and is mixed with the silicone resin composition preferably contains an unsaturated compound having a hydroxyl group represented by the general formula (4) 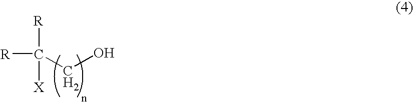
(where R is an organic functional group containing a (meth)acryloyl group, X represents an organic functional group containing hydrogen or (meth)acryloyl group, and n is an integer of 0 or 1).

The silica fine particles, which are added to the silicone resin composition, have an average particle size of 1 to 100 nm and are preferably treated with a silicone compound of 0.1 to 80 wt % with respect to silica fine particles represented by the general formula (5)
RₘSiAₙX₄₋ₘ₋ₙ (5)
(where R is an organic functional group containing a (meth)acryloyl group, A is an alkyl group, X is an alkoxyl group or a halogen atom, m and n satisfy an integer in which m+n is of 1 to 3, m is an integer of 0 or 1, and n is an integer of 0 to 3), and a mixing amount of silica fine particles satisfies 1 to 70 wt % with respect to the silicone resin composition.

The present invention relates to a silica-containing silicone resin molded article prepared by radical copolymerization with the above-mentioned silica-containing silicone resin composition. The present invention further relates to a silica-containing silicone resin molded article having the coefficient of linear thermal expansion of 40 ppm/K or less, the entirety light transmittance of 85% or more, and the glass transition temperature of 300° C. or more.

A silica-containing silicone resin composition of the present invention includes a silicone resin, an unsaturated compound copolymerizable with the silicone resin, and a silica fine particle as main ingredients. A silica-containing silicone resin composition is radically copolymerized to yield a silica-containing silicone resin copolymer of the present invention. The silica-containing silicone resin composition is molded with cure or the silica-containing silicone resin copolymer is molded to give a molded article of the present invention. The silica-containing silicone resin copolymer of the present invention is a crosslinked polymer, and a method of molding with cure similar to the method used for thermosetting resins can be adopted here.

Silicone resins useful for the execution of the present invention includes as main ingredients polyorganosilsesquioxanes (also referred to as cage type polyorganosilsesquioxanes) which are represented by the general formula (1) and have a cage type structure in the constitutional unit.

In the general formula (1), R is an organic functional group containing a (meth)acryloyl group and n is 8, 10, or 12; preferably, R is an organic functional group represented by the following the general formula (9): where m is an integer of 1 to 3 and R₁ is hydrogen atom or methyl group.

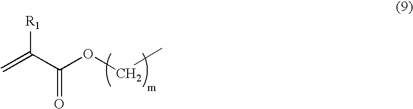

The conventional silicone resins, regardless of ladder type or nonladder type, are poorly compatible with organic compounds containing a functional group such as acrylic resins and it was impossible to obtain transparent molded articles from those compositions. The silicone resins, however, assume a quasi-micelle structure because the reactive functional groups highly compatible with organic compounds project out of the cage while the siloxane framework poorly compatible with organic compounds is held inside the cage. As a result, the resins can be mixed with unsaturated compounds such as acrylic monomers and oligomers at an arbitrary ratio.

A cage type polyorganosilsesquioxane represented by the general formula (1) has a reactive functional group on each silicone atom in the molecule. Specifically, the cage type polyorganosilsesquioxane corresponding to the case where n in the general formula (1) is 8, 10, or 12 has a cage type structure shown by the following structural formula (6), (7), or (8). R in the following structural formulae is similar to R in the general formula (1).

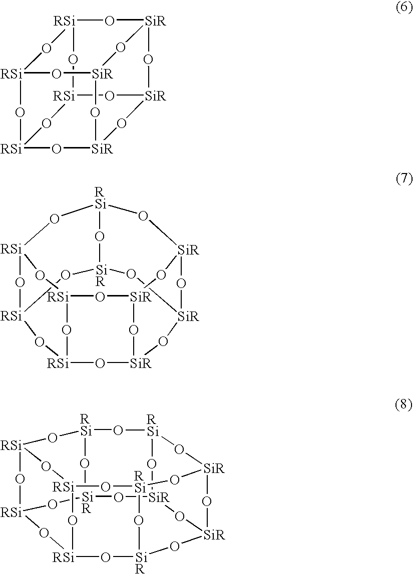

A cage type polyorganosilsesquioxane represented by the general formula (1) can be produced by a method disclosed in Patent Document 5. For example, the cage type polyorganosilsesquioxane can be prepared by subjecting a silicone compound represented by the general formula (3) to hydrolysis and partial condensation in a polar solvent in the presence of a basic catalyst, and further subjecting the hydrolysis product thus obtained to recondensation in a nonpolar solvent in the presence of a basic catalyst. In the general formula (3), R is an organic functional group containing a (meth)acryloyl group and X is a hydrolyzable group. R is preferably a group represented by the general formula (9). Preferred examples of R include 3-methacryloyloxypropyl, methacryloyloxymethyl, and 3-acryloyloxypropyl groups.

The hydrolyzable group X in the general formula (3) is not limited as long as it is hydrolyzable. Examples of the hydrolyzable group X include alkoxy and acetoxy groups. Of those, an alkoxy group is preferable. Examples of the alkoxy groups include methoxy, ethoxy, n- and i-propoxy, and n-, i-, and t-butoxy groups. Of those, the methoxy groups having high reactivity are preferable.

Preferred examples of the silicone compounds represented by the general formula (3) include methacryloyloxymethyl triethoxysilane, methacryloyloxymethyl trimethoxysilane, 3-methacryloyloxypropyl trichlorosilane, 3-methacryloyloxypropyl trimethoxysilane, 3-methacryloyloxypropyl triethoxysilane, 3-acryloyloxypropyl trimethoxysilane, and 3-acryloyloxypropyl trichlorosilane. Of those, 3-methacryloyloxypropyl trimethoxysilane is preferably used because a raw material of thereof readily available.

Examples of the basic catalysts used for the hydrolysis reaction include alkali metal hydroxides such as potassium hydroxide, sodium hydroxide, and cesium hydroxide and ammonium hydroxides such as tetramethylammonium hydroxide, tetraethylammonium hydroxide, tetrabutylammonium hydroxide, benzyltrimethylammonium hydroxide, and benzyltriethylammonium hydroxide. Of those, tetramethylammonium hydroxide is used preferably because of its high catalytic activity. The basic catalyst is normally used as an aqueous solution.

In effecting the hydrolysis reaction, the reaction temperature is preferably 0 to 60° C., more preferably 20 to 40° C. When the reaction temperature is below 0° C., the reaction rate decreases and the hydrolyzable groups remain unreacted, resulting in a prolonged reaction time. On the other hand, when the temperature is above 60° C., the reaction rate increases too much thereby causing complicated condensation reactions. As a result, the polymerization of the hydrolysis products is facilitated. The reaction time is preferably two hours or more. When the reaction time is less than two hours, the hydrolysis reaction does not proceed sufficiently and the hydrolyzable groups remain unreacted.

The presence of water is indispensable for the hydrolysis reaction. Water may be supplied from the aqueous solution of the basic catalyst or may be added separately. Water should be present in an amount more than enough for the hydrolysis of the hydrolyzable groups, preferably 1.0 to 1.5 times the theoretical amount. Moreover, it is necessary to use an organic polar solvent during hydrolysis, and an alcohol such as methanol, ethanol, and 2-propanol or other organic polar solvent may be used as an organic polar solvent. A water-soluble lower alcohol having 1 to 6 carbon atoms and 2-propanol are preferable. The use of a nonpolar solvent is not preferable because the reaction system does not become homogeneous, the hydrolysis reaction does not proceed sufficiently, and the unreacted alkoxy groups remain.

Upon completion of the hydrolysis reaction, the water or the water-containing reaction solvent is separated. The separation of the water or the water-containing reaction solvent is performed by such means as evaporation under reduced pressure. For satisfactory separation of the water or other impurities, for example, the hydrolysis reaction product is dissolved by adding a nonpolar solvent thereto, the resulting solution is washed with a solution of sodium chloride or the like, and then the washed solution is dried over a drying agent of anhydrous magnesium sulfate. The nonpolar solvent is separated by means of evaporation and the like to recover the hydrolysis product. However, the separation need not be performed if the nonpolar solvent can be used as a nonpolar solvent in the next reaction.

In the hydrolysis reaction of the present invention, the condensation reaction of the hydrolysis product proceeds at the same time. The hydrolysis product accompanied by condensation reaction of the hydrolysis product normally becomes a colorless viscous liquid with a number average molecular weight of 1,400 to 5,000. Depending upon the reaction conditions, the hydrolysis product becomes an oligomer with a number average molecular weight of 1,400 to 3,000, and the majority, preferably practically the whole, of the hydrolyzable group X represented by the general formula (3) is replaced by OH groups and the majority, preferably 95% or more, of such OH groups is condensed. The hydrolysis product has a structure of several types such as cage, ladder, or random-type silsesquioxanes. Even the cage type compound hardly has a perfect cage type structure and an imperfect cage type structure with part of the cage open is mainly adopted. Consequently, the hydrolysis product obtained through hydrolysis is further heated in an organic solvent in the presence of a basic catalyst to effect condensation of siloxane linkages (referred to as recondensation), thereby selectively producing cage type silsesquioxanes.

After separation of the water or water-containing reaction solvent, the recondensation reaction is carried out in a nonpolar solvent in the presence of a basic catalyst. According to conditions of the recondensation reaction, the reaction temperature is preferably within the range of 100 to 200° C., more preferably 110 to 140° C. When the temperature is too low, a driving force sufficient for advancement of the recondensation reaction is not generated and the reaction does not proceed. When the temperature is too high, the (meth)acryloyl groups may undergo self-polymerization. Thus, it is necessary to control the reaction temperature at a proper level or to add a polymerization inhibitor or the like. The reaction time is preferably 2 to 12 hours. The nonpolar solvent is preferably used in an amount enough to dissolve the hydrolysis product, and the basic catalyst is used in an amount corresponding to 0.1 to 10 wt % with respect to the hydrolysis product.

The nonpolar solvent may be any solvent which is insoluble or scarcely soluble in water, and a hydrocarbon solvent is preferred. Examples of the hydrocarbon solvents include low-boiling nonpolar solvents such as toluene, benzene, and xylene. Of those, toluene is preferably used. Examples of the basic catalyst include basic catalysts to be used in hydrolysis reaction, for example, alkali metal hydroxides such as potassium hydroxide, sodium hydroxide, and cesium hydroxide and ammonium hydroxides such as tetramethylammonium hydroxide, tetraethylammonium hydroxide, tetrabutylammonium hydroxide, benzyltrimethylammonium hydroxide, and benzyltriethylammonium hydroxide. The catalysts which are soluble in nonpolar solvents, such as tetraalkylammonium are preferable.

It is desirable to carry out water washing, dewatering, and concentration for the hydrolysis product prior to recondensation, but water washing and dewatering may be omitted. Water may be present during the recondensation reaction, but explicit addition of water is not necessary and it suffices to keep the amount of water to somewhere near that brought in by the basic catalyst solution. In the cases where the hydrolysis of the hydrolysis product is not carried out sufficiently, it is necessary to add water in an amount more than the theoretical amount needed to hydrolyze the remaining hydrolyzable groups. Usually, the hydrolysis reaction is carried out sufficiently. After the recondensation reaction, the reaction mixture is washed with water to remove the catalyst and is concentrated to obtain a mixture of silsesquioxanes.

The silsesquioxanes obtained in this manner are constituted of several kinds of cage type silsesquioxanes which account for 70% or more of the total, although their composition varies with the reaction conditions and the condition of the hydrolysis product. For example, the cage type silsesquioxanes are constituted of 20 to 40% of T8 or the compound represented by the general formula (6) and 40 to 50% of T10 or the compound represented by the general formula (7), and the remainder is T12 or the compound represented by the general formula (8). The compound T8 can be separated as needle crystals by leaving the siloxane mixture standing at 20° C. or below. The silicone resins to be used in the present invention may be a mixture of T8 to T12 and may be obtained by separation or condensation of one or two cage type silsesquioxanes in compounds T8 or the like. Further, the silicone resins to be used in the present invention are not limited to the silicone resins obtained by above-mentioned the method.

According to a silica-containing silicone resin composition of the present invention, an unsaturated compound to be used with the silicone resin contains at least one unsaturated group represented by —R³—CR⁴═CH₂ or —CR⁴═CH₂ in the molecule and is capable of undergoing radical copolymerization with the silicone resin. The group R³ represents an alkylene group, alkylidene group, or a —OCO— group, and lower alkylene and alkylidene groups containing 1 to 6 carbon atoms are preferable as the alkylene and alkylidene groups. The group R⁴ represents hydrogen or an alkyl group, preferably hydrogen or methyl group. The preferable unsaturated group includes at least one kind selected from groups of acryloyl, methacryloyl, allyl, and vinyl groups. Examples of the unsaturated preferable compound include an unsaturated compound having a hydroxyl group represented by the general formula (4) or an unsaturated compound represented by A¹-(R³—CR⁴═CH₂) n or A²-(CR⁴═CH₂)ₙ. In this case, it is preferable that A¹ and A² each be an aliphatic hydrocarbon group or an aromatic hydrocarbon group having 1 to 20 carbon atoms and valency of n. The aliphatic hydrocarbon group may be a cyclic aliphatic hydrocarbon group, but preferably does not have an olefinic double bond. It is preferable that n be an integer of 1 to 8. In addition, it is desirable for the unsaturated compound to not have Si in the molecule.

The silica-containing silicone resin composition of the present invention includes as main ingredients A) the silicone resin and B) the unsaturated compound having an unsaturated group and capable of undergoing copolymerization with the silicone resin. The mix ratio ranges from 1:99 to 99:1 and, when the content of the silicone resin is assumed as A and that of the unsaturated compound is assumed as B, the ratio A/B preferably has a range of 10/90≦A/B≦80/20, more preferably 20/80≦A/B≦60/40. The case where the content of the silicone resin is less than 10% is undesirable because the molded articles after curing show deterioration in physical properties such as heat resistance, transparency, and water absorption properties the case where the content of the silicone resin exceeds 80% is undesirable because the silicone resin composition increases in viscosity and the production of molded articles becomes difficult.

The unsaturated compounds are classified into an unsaturated compound with a hydroxyl group represented by the general formula (4) and an unsaturated compound without a hydroxyl group. In the general formula (4), R is an organic functional group containing a (meth)acryloyl group, X is hydrogen or an organic group functional containing a (meth)aryloyl group, and n is an integer of 0 or 1. An unsaturated compound containing a hydroxyl group is preferable to obtain a molded article with excellent transparency. The reason is as follows. A hydroxyl group acts on silanol group present on a surface of a silica fine particle to suppress aggregation of silica fine particles. As a result, dispersion of silica fine particles in the resin is increased. On the other hand, in the case of mixing a large amount of silica fine particles in an unsaturated compound without a hydroxyl group, the silica fine particles are not uniformly dispersed in a resin due to aggregation, so the transparency may become degenerated. From another viewpoint, the unsaturated compounds are roughly divided into reactive oligomers as polymers containing about 2 to 20 repeating constitutional units and reactive monomers of low molecular weight and low viscosity. They are also roughly divided into monofunctional unsaturated compounds containing a single unsaturated group and polyfunctional unsaturated compounds containing two or more functional groups. Further, a polyfunctional unsaturated compounds are classified into an non-alicyclic unsaturated compound without an alicyclic structure in a molecule structure and an alicyclic unsaturated compound with an alicyclic structure. It is better to keep the amount of polyfunctional unsaturated compounds at an extremely low level, about 1% or less, in order to obtain a good three-dimensional crosslinked product. In the case of expecting good heat resistance, high strength and the like of the copolymer, it is better to have the molecule contain 1.1 or more, preferably 1.5 or more, more preferably 1.6 to 5 of unsaturated groups in average. For this purpose, a monofunctional unsaturated compound is preferably mixed with a polyfunctional unsaturated compound containing 2 to 5 unsaturated groups to adjust an average number of functional groups.

Examples of the reactive oligomers include epoxy acrylates, epoxidized oil acrylates, urethane acrylates, unsaturated polyesters, polyester acrylates, polyether acrylates, vinyl acrylates, polyene/thiol, silicone acrylates, polybutadiene, and polystyrylethyl methacrylate. Those compounds occur as monofunctional or polyfunctional compounds.

Examples of the reactive monofunctional monomers include styrene, vinyl acetate, N-vinylpyrrolidone, butyl acrylate, 2-ethylhexyl acrylate, n-hexyl acrylate, cyclohexyl acrylate, n-decyl acrylate, isobornyl acrylate, dicyclopentenyloxyethyl acrylate, phenoxyethyl acrylate, and trifluoroethyl methacrylate.

Examples of the reactive non-alicyclic polyfunctional monomers include tripropylene glycol diacrylate, 1,6-hexanediol diacrylate, bisphenol A diglycidyl ether diacrylate, tetraethylene glycol diacrylate, hydroxypivalic acid neopentyl glycol diacrylate, trimethylolpropane triacrylate, pentaerythritol triacrylate, pentaerythritol tetraacrylate, and dipentaerythritol hexaacrylate. Of the reactive non-cyclic polyfunctional monomers, examples of the monomers containing a hydroxy group represented by the general formula (4) include pentaerythritol triacrylate, glycerin dimethacrylate, and glycerol acrylate methacrylate. The monomers are capable of interacting with a hydroxyl group present on a surface of a silica fine particle because the monomers contain a hydroxyl group in molecules. Also, an amount of silica fine particles in a resin composition is regulated so that they can be homogeneously blended in the resin in a large amount.

A reactive alicyclic polyfunctional monomer is represented by the general formula (2) 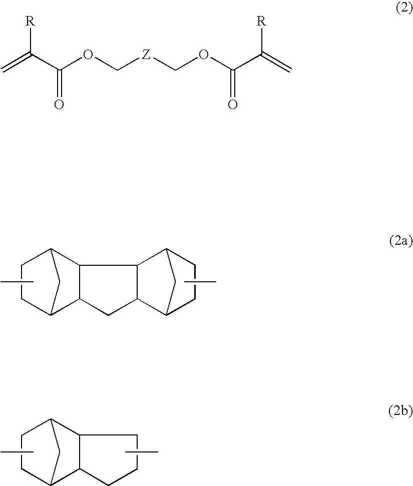
(where Z represents any one of the groups represented by the formula (2a) or (2b) and R represents hydrogen or a methyl group). When Z is the group represented by the formula (2a), specific example of the compound thereof includes pentacyclo[6.5.1.1^{3,6}.0^{2,7}.0^{9,13}]pentadecanedimethylol diacrylate in which R is hydrogen. When Z is the group represented by the formula (2b), specific example of the compound thereof includes dicyclopentanyldimethylol diacrylate (also, tricyclo[5.2.1.0^{2,6}]decanedimethylol diacrylate) in which R is hydrogen.

A variety of reactive oligomers and monomers other than the examples given above can be used as unsaturated compounds to be used in the present invention. Those reactive oligomers and monomers may be used alone or as a mixture of two kinds or more. However, in the case where A) a silicone resin, B) an unsaturated compound, and C) an unsaturated compound other than B), monomer, or oligomer are used, the wt % obtained by C/(B+C) is controlled to 50 wt % or less, preferably 20 wt % or less.

The silica fine particle of a silica-containing silicone resin composition of the present invention is not particularly limited as long as the fine particle is silicone oxide and has an average particle size of 1 to 100 nm. A dried silica fine particle and a colloidal silica dispersed in an organic solvent can be used as the silica fine particle. The colloidal silica dispersed in an organic solvent is preferably used from the viewpoint of dispersing to a silica fine particle into a silicone resin composition and treating the silica fine particle with a silicone compound. Examples of the organic solvent in the case of using a colloidal silica dispersed in the organic solvent preferably include those capable of dissolving a silicone resin composition, such as alcohols, ketones, esters, and glycol ethers. Of those, alcohols such as methanol, ethanol, propylalcohol, isopropylalcohol, and butylalcohol are preferably used as an organic solvent from the viewpoint of ready desolvation after treating the silica fine particle with a silane compound and dispersing the silica fine particle into a silicone resin.

A silica fine particle having an average particle size of 1 to 100 nm is preferable. A silica fine particle having an average particle size of 5 to 50 nm can be more preferably used from the viewpoint of balances in transparency and viscosity of a silica-containing silicone resin composition and mixing amount and dispersibility of a silica fine particle. Several kinds of silica fine particles with different average particle sizes in a range of 1 to 100 nm can be used. In the case of a silica fine particle having an average particle size of less than 1 nm, viscosity of a silica-containing resin composition increases by mixing a silica fine particle, and it becomes difficult to uniformly disperse the silica fine particle and to produce a molded article. As a result, the mixing amount of the silica fine particle is limited. In addition, in the case of an average particle size of 100 nm or more, transparency of a molded article remarkably degenerates.

As of the mixing amount of the silica fine particle in silica-containing silicone resin composition of the present invention, it is preferable that the silica fine particle be added to the silicone resin composition in a range of 1 to 70 wt %. From the viewpoint of balances in viscosity of the silica-containing silicone resin composition and a coefficient of thermal expansion coefficient thereof, the silica fine particle in a range of 5 to 70 wt % is more preferable and the silica fine particle in a range of 10 to 50 wt % is still more preferable. In those ranges, a molded article which is excellent in low-thermal expansivity and transparency and which is easily produced can be obtained. When a mixing amount of a silica fine particle is less than 1 wt %, a low-thermal expansivity cannot be exerted. When a mixing amount of a silica fine particle is 70 wt % or more, it is difficult for a molded article to be produced because viscosity of a silica-containing resin composition increases.

Viscosity of a silica-containing silicone resin composition of the present invention is, from viewpoint of possibility of being molded, generally 100 to 120,000 mPa·s, preferably 500 to 90,000 mPa·s, more preferably 1,000 to 50,000 mPa·s. In those ranges, a molded article with a predetermined thickness can be prepared with good productivity. In the case of 100 mPa·s or less, the viscosity is too low to produce a molded article with a predetermined thickness. In the case of 120,000 mPa·s or more, productivity in a molded article remarkably decreases because of high viscosity.

A silane compound can be used to treat a surface of a silica fine particle. The silane compound is useful for inhibition of aggregation of the silica fine particle, improvement in dispersion stability of the silica fine particle, and reduction in the viscosity of the silica-containing silicone resin composition. The amount of the silane compound to be treated is 0.1 to 80 wt % with respect to the silica fine particle, preferably 0.5 to 50 wt %, more preferably 0.5 to 30 wt %. When the amount of the silane compound is less than 0.5 wt %, it is difficult to produce a molded article because the effect of aggregation inhibition of the silica fine particle is lost and viscosity of the silica-containing silicone resin composition increases. Further, the amount of the silane compound of 50 wt % or more is not preferable because the effect of low-thermal expansion owing to mixing of a silica fine particle decreases. An example of a method of treating the silica fine particle with the silane compound includes a method which involves: mixing a colloidal silica that is dispersed in an organic solvent with a silane compound; stirring the mixture that is added with a small amount of water if necessary; and heating the mixture such that reduction in the organic solvent due to heating does not occur.

The compounds represented by the general formula (5) can be preferably used as silane compounds.

Specific examples of the compounds include 3-acryloyloxypropyldimethylmethoxysilane, 3-acryloyloxypropylmethyldimethoxysilane, 3-acryloyloxypropyldiethylmethoxysilane, 3-acryloyloxypropylethyldimethoxysilane, 3-acryloyloxypropyltrimethoxysilane, 3-acryloyloxypropyldimethylethoxysilane, 3-acryloyloxypropylmethyldiethoxysilane, 3-acryloyloxypropyldiethylethoxysilane, 3-acryloyloxypropylethyldiethoxysilane, 3-acryloyloxypropyltriethoxysilane, 3-methacryloyloxypropyldimethylmethoxysilane, 3-methacryloyloxypropylmethyldimethoxysilane, 3-methacryloyloxypropyldiethylmethoxysilane, 3-methacryloyloxypropylethyldimethoxysilane, 3-methacryloyloxypropyltrimethoxysilane, 3-methacryloyloxypropyldimethylethoxysilane, 3-methacryloyloxypropylmethyldiethoxysilane, 3-methacryloyloxypropyldiethylethoxysilane, 3-methacryloyloxypropylethyldiethoxysilane, 3-methacryloyloxypropyltriethoxysilane, methyltrimethoxysilane, dimethylmethoxysilane, trimethoxysilane, ethyltrimethoxysilane, diethyldimethoxysilane, triethylmethoxysilane, propyltrimethoxysilane, dipropyltrimethoxysilane, tripropylmethoxysilane, isopropyltrimethoxysilane, diisopropyldimethoxysilane, triisopropylmethoxysilane, methyltriethoxysilane, dimethyldiethoxysilane, triethoxysilane, ethyltriethoxysilane, diethyldiethoxysilane, triethylethoxysilane, propyltriethoxysilane, dipropyltriethoxysilane, tripropylethoxysilane, isopropyltriethoxysilane, diisopropyldiethoxysilane, and triisopropylethoxysilane. Those compounds may be used alone or two or more kinds of them may be used in combination.

The silica-containing silicone resin compositions of the present invention can be converted into silica-containing silicone resin copolymers by radical copolymerization. For the purpose of improving the physical properties of the silica-containing silicone resin copolymers or of promoting the radical copolymerization, a variety of additives can be incorporated in the silica-containing silicone resin compositions of the present invention. Additives useful for promoting the reaction include thermal polymerization initiators, thermal polymerization promoters, photopolymerization initiators, photoinitiation auxiliaries, sensitizers, and the like. In the case where a photopolymerization initiator or a thermal polymerization initiator is used, its addition is made at a rate of 0.1 to 5 parts by weight, preferably 0.1 to 3 parts by weight, with respect to 100 parts by weight of the sum of the silicone resin, unsaturated compound, and silica fine particle. Addition of less than 0.1 part by weight causes insufficient curing and yields a molded article with lower strength and rigidity. On the other hand, addition in excess of 5 parts by weight may cause problems such as color development on molded articles.

Preferred examples of the photopolymerization initiators to be used when silica-containing silicone resin compositions are used as photocurable compositions include compounds derived from acetophenone, benzoin, benzophenone, thioxanthone, and acylphosphine oxides. Specific examples thereof include trichloroacetophenone, diethoxyacetophenone, 1-phenyl-2-hydroxy-2-methylpropan-1-one, 1-hydroxycyclohexyl phenyl ketone, 2-methyl-1-(4-methylthiophenyl)-2-morpholinopropan-1-one, benzoin methyl ether, benzyl dimethyl ketal, benzophenone, thioxanthone, 2,4,6-trimethylbenzoyldiphenylphosphine oxide, methylphenyl glyoxylate, camphorquinone, benzil, anthraquinone, and Michler's ketone. Those photopolymerization initiators may be used together with photoinitiation auxiliaries and sensitizers which work effectively in combination.

Preferred examples of the thermal polymerization initiators to be used for the purpose include various kinds of organic peroxides derived from ketone peroxide, peroxy ketal, hydroperoxide, dialkyl peroxide, diacyl peroxide, peroxydicarbonate, and peroxyester. Specific examples of the thermal polymerization initiators include, but not limited to, cyclohexanone peroxide, 1,1-bis(t-hexaperoxy)cyclohexanone, cumene hydroperoxide, dicumyl peroxide, benzoyl peroxide, diisopropyl peroxide, and t-butylperoxy-2-ethylhexanoate. Those thermal polymerization initiators can be used alone or two or more kinds of them can be used as a mixture.

A variety of additives can be incorporated in the silica-containing silicone resin compositions of the present invention as long as the incorporation does not deviate from the scope of the present invention. Examples of the various additives include organic and inorganic fillers, plasticizers, flame retardants, heat stabilizers, antioxidants, light stabilizers, ultraviolet absorbers, lubricants, antistatic agents, mold release agents, foaming agents, nucleating agents, colorants, crosslinking agents, dispersing agents, and resin components.

The silica-containing silicone resin composition of the present invention is converted into a silicone resin copolymer by radical copolymerization or it is formed into a specific shape and radically copolymerized to obtain a molded article of a silica-containing silicone resin copolymer. A variety of molding methods can be adopted when the silica-containing silicone resin copolymer obtained is thermoplastic. However, the copolymer assumes a three-dimensional crosslinked structure when the number of reactive substituents or unsaturated groups in the molecule exceeds 1.0 and molding with cure is normally adopted in such a case. Therefore, radical copolymerization is also called curing. Radical copolymerization is effected by heating or irradiation with energy rays such as electron rays and ultraviolet light.

A silica-containing silicone resin copolymer of the present invention can be produced by curing a silica-containing silicone resin composition containing a radical polymerization initiator by heating or photoirradiation. In the case where the copolymer (molded article) is produced by heating, the molding temperature can be selected from a wide range from room temperature to around 200° C. by selection of thermal polymerization initiators and promoters. In this case, a silica-containing silicone resin molded article of a desired shape can be produced by effecting polymerization and curing inside a mold or on a steel belt.

In the case where the copolymer (molded article) is produced by photoirradiation, ultraviolet light with wavelengths of 10 to 400 nm or visible light with wavelengths of 400 to 700 nm is used for the irradiation to obtain a molded article. The wavelength of light to be used is not limited, but near ultraviolet light with wavelengths of 200 to 400 nm is preferable. Examples of lamps to be used as a source of ultraviolet light include low-pressure mercury lamps (power output: 0.4 to 4 W/cm), high-pressure mercury lamps (40 to 160 W/cm), ultrahigh-pressure mercury lamps (173 to 435 W/cm), metal halide lamps (80 to 160 W/cm), pulsed xenon lamps (80 to 120 W/cm), and electrodeless discharge lamps (80 to 120 W/cm). Those lamps show characteristic spectral distributions and lamp selection is made in consideration of the kind of photoinitiator in use.

According to a method of preparing silica-containing silicone resin copolymers (molded articles) by the photoirradiation, there is exemplified a method of producing a molded article of a desired shape, which includes: injecting a silica-containing silicone resin into a mold having a cavity of a given shape and composed of a transparent material such as quartz glass; subjecting the resultant to polymerization/curing by irradiating ultraviolet rays with the ultraviolet lamp; and taking a resultant molded article out of the mold. In the case where a mold is not used, there is exemplified a method of producing a molded article in a sheet form, which includes: applying a silica-containing silicone resin composition of the present invention on a moving steel belt by using a doctor blade or roll coater; and subjecting the resultant to polymerization/curing with the ultraviolet lamp.

Thus obtained silica-containing silicone resin copolymer (molded article) of the present invention shows a glass transition temperature of more than 300° C. as measured with a dynamic thermomechanical analyzer (DMA), a total light transmittance of 85% or more, and a coefficient of linear thermal expansion of 40 ppm/K or less. Accordingly, the silicone resin compositions of the present invention can retain heat resistance, transparency, and dimension stability.

### EXAMPLES

Hereinafter, examples of the present invention will be described. The silicone resins used in the examples were prepared by the method described in Synthesis Example 1 described below.

### Synthesis Example 1

In a reaction vessel equipped with a stirrer, a dropping funnel, and a thermometer, 40 ml of 2-propanol (IPA) as a solvent and a 5% aqueous solution of tetramethylammonium hydroxide (aqueous solution of TMAH) as a basic catalyst were introduced. In the dropping funnel, 15 ml of IPA and 12.69 g of 3-methacryloyloxypropyltrimethoxysilane (available as SZ-6030 from Dow Corning Toray Silicone Co., Ltd.) were placed. The IPA solution of 3-methacryloyloxypropyltnimethoxysilane was added in drops over a period of 30 minutes at room temperature while stirring the reaction vessel. Upon completion of the addition of 3-methacryloyloxypropyltrimethoxysilane, the reaction mixture was stirred for 2 hours without heating. After 2-hour stirring, the solvent was removed under reduced pressure and the residue was dissolved in 50 ml of toluene. The reaction solution washed with a saturated aqueous solution of sodium chloride until the solution became neutral, and was dehydrated over anhydrous magnesium sulfate. The magnesium sulfate was filtered off and the solution was concentrated to give 8.6 g of the hydrolysis product (silsesquioxane). The silsesquioxane was a colorless viscous liquid soluble in various organic solvents.

In a reaction vessel equipped with a stirrer, a Dean-Stark trap, and a condenser, 20.65 g of the silsesquioxane obtained above, 82 ml of toluene, and 3.0 g of a 10% aqueous solution of TMAH were placed, and the mixture was heated gradually to distil off the water. The mixture was further heated to 130° C. and allowed toluene to undergone recondensation at the reflux temperature. The temperature of the reaction solution at this point was 108° C. The reaction solution was stirred for 2 hours after the toluene reflux to complete the reaction. The reaction solution washed with a saturated aqueous solution of sodium chloride until becoming neutral and was dehydrated over anhydrous magnesium sulfate. The magnesium sulfate was filtered off and the filtrate was concentrated to give 18.77 g of the target cage type silsesquioxanes (mixture). The obtained target cage type silsesquioxanes was a colorless viscous liquid soluble in various organic solvents.

The products after the recondensation reaction were dispersed by liquid chromatography and then analyzed by mass spectrometry. As a result, molecular ions in which ammonium ions were attached to the molecule structures represented by the structural formulae (6), (7), and (8) were determined. Also, it was confirmed that the structural ratio of T8:T110:T12 and others was about 2:4:1:3, and the products were silicone resins mainly composed of cage-type structures. Note that T8, T10, and T12 correspond to formulae (6), (7), and (8), respectively.

### Example 1

In a reaction vessel equipped with a stirrer, a thermometer, and a condenser, 150 parts by weight of isopropanol dispersed colloidal silica sol (particle size of 10 to 20 nm, solid content of 30 wt %, water of 0.5 wt %, and available as IPA-ST from NISSAN CHEMICAL INDUSTRIES, LTD.) (silica solid content of 30 parts by weight) as silica fine particles and 7.2 parts by weight of 3-methacryloyloxypropyltrimethoxysilane (available as SZ-6030 from Dow Corning Toray Silicone Co., Ltd.) as silane compounds were introduced and the mixture was heated gradually while stirring. The mixture was further heated for 5 hours after the temperature of the reaction solution reduced 68° C., and then the treatment of a silica fine particle was performed. The resultant was mixed with 55 parts by weight of a silicone resin composition (25 parts by weight of cage type silicone resin having a methacryloyl group on each of silicone atoms, which was obtained in Synthesis Example 1 and 75 parts by weight of dipentaerythritol hexaacrylate), and the mixture was heated gradually under reduced pressure to remove a volatile solvent. At that time, the final temperature was 80° C. Then, the mixture was mixed with 2.5 parts by weight of 1-hydroxycyclohexyl phenyl ketone as a photopolymerization initiator, to thereby obtain a transparent silica-containing silicone resin composition.

Next, a molded article of sheet silicone resin with desired thickness was prepared by casting (flowing cast) to have a thickness of 0.4 mm by using a roll coater and being cured with an accumulated light exposure of 8,000 mJ/cm² by using a high-pressure mercury lamp with 30 W/cm.

### Examples 2 to 6

A resin molded article was obtained in the same matter as in example 1 except that a mixing composition was changed to the ratio shown in Table 1. The physical properties of the obtained molded articles are shown in Table 2.

### Comparative Example 1

25 parts by weight of cage type silicone resin having a methacryloyl group on each of silicone atoms, which was obtained in Synthesis Example 1, 75 parts by weight of dipentaerythritol hexaacrylate, and 2.5 parts by weight of 1-hydroxycyclohexyl phenyl ketone as a photopolymerization initiator were mixed, to thereby obtain a transparent silicone resin composition.

Next, a molded article of sheet silicone resin with desired thickness was prepared by casting (flowing cast) to have a thickness of 0.4 mm by using a roll coater and being cured with an accumulated light exposure of 8,000 mJ/cm² by using a high-pressure mercury lamp with 30 W/cm.

### Comparative Example 2

A resin molded article was obtained in the same matter as in Comparative Example 1 except that a mixing composition was changed to the ratio shown in Table 1. The physical properties of the obtained molded articles are shown in Table 2.

The symbols used in Tables are as follows.

A: Silica solid content

B: 3-methacryloyloxypropyltrimethoxysilane (available as SZ-6030 from Dow Corning Toray Silicone Co., Ltd.)

C: Silicone resin composition 1 (25 parts by weight of the compound obtained in Synthesis Example 1 and 75 parts by weight of dipentaerythritol hexaacrylate)

D: Silicone resin composition 2 (25 parts by weight of the compound obtained in Synthesis Example 1 and 75 parts by weight of pentaerythritol hexaacrylate)

E: Silicone resin composition 3 (25 parts by weight of the compound obtained in Synthesis Example 1 and 75 parts by weight of glycerin dimethacrylate)

F: Silicone resin composition 4 (25 parts by weight of the compound obtained in Synthesis Example 1, 55 parts by weight of pentaerythritol triacrylate, and 20 parts by weight of glycerin dimethacrylate)

G: 1-hydroxycyclohexyl phenyl ketone (polymerization initiator)

TABLE 1

| | A | B | C | D | E | F | G |
|---|---|---|---|---|---|---|---|
| Example 1 | 45 | 7.2 | 55 | — | — | — | 2.5 |
| 2 | 30 | 1.3 | 70 | — | — | — | 2.5 |
| 3 | 25 | 0.25 | 75 | — | — | — | 2.5 |
| 4 | 30 | 1.3 | — | 70 | — | — | 2.5 |
| 5 | 20 | 0.78 | — | 80 | — | — | 2.5 |
| 6 | 50 | 4.0 | — | — | 50 | — | 2.5 |
| 7 | 44 | 3.5 | — | — | — | 56 | 2.5 |
| Comparative | — | — | 100 | — | — | — | 2.5 |
| Example 1 | | | | | | | |
| 2 | — | — | — | 100 | — | — | 2.5 |
| 3 | — | — | — | — | 100 | — | 2.5 |
| 4 | — | — | — | — | — | 100 | 2.5 |

TABLE 2

| | Glass | Total light | Coefficient | | |
|---|---|---|---|---|---|
| | transition | trans- | of linear | | |
| | temperature | mittance | expansion | Viscosity | Mold- |
| | (° C.) | (%) | (ppm/K) | (mPa · s) | ability |
| Example 1 | >300 | 89 | 31 | >100000 | Δ |
| 2 | >300 | 89 | 37 | >100000 | Δ |
| 3 | >300 | 89 | 35 | >100000 | Δ |
| 4 | >300 | 89 | 32 | >100000 | Δ |
| 5 | >300 | 89 | 36 | >100000 | Δ |
| 6 | >300 | 89 | 27 | 23000 | ◯ |
| 7 | >300 | 89 | 31 | 87000 | ◯ |
| Comp. | >300 | 89 | 46 | 5500 | ◯ |
| Example 1 | | | | | |
| 2 | >300 | 89 | 48 | 811 | ◯ |
| 3 | >300 | 89 | 70 | 90 | Δ |
| 4 | >300 | 89 | 53 | 393 | ◯ |

1) Glass transition temperature: determined by dynamic thermomechanical analysis; rate of temperature rise, 5° C./min; distance between chucks, 10 mm

2) Total light transmittance (determined in conformity with JIS K 7361-1): thickness of specimen, 0.4 mm

3) Coefficient of linear thermal expansion: determined by thermomechanical analysis; rate of temperature rise, 5° C./min; compression load, 0.1N

4) Viscosity: E-type viscometer (23° C.)

5) Moldability: thickness of the molded article obtained by casting 30 g of a resin, and after 18 minutes, curing the casted product with a load of 40 kg is indicated by ◯, Δ, or X. Here, ◯, Δ, and X represent “less than ±5%”, “less than ±10%”, and “±10% or more” in predetermined thickness, respectively.

### INDUSTRIAL APPLICABILITY

According to the present invention, it is possible to obtain molded articles with excellent heat resistance, transparency, and dimension stability. The molded articles can be used for optical applications such as lenses, optical disks, optical fibers, and substrates for flat panel displays, or for window materials for various transport machines, houses, and the like. The molded articles are transparent, light, and highly resistant to impact, and they are industrially valuable because they can be widely used as substitutes for glass.

1. A silica-containing silicone resin composition, characterized by containing 5 to 70 wt % of silica fine particles having an average particle size of 1 to 100 nm in a silicone resin composition, which is formulated with a cage type silicone resin mainly constituted of a polyorganosilsesquioxane represented by the general formula (1)
[RSiO_{3/2}]ₙ (1)
where R is an organic functional group containing a (meth)acryloyl group and n is 8, 10, or 12; and containing a cage type structure in its constitutional unit; and
an unsaturated compound containing at least two unsaturated group represented by —R³—CR⁴═CH₂ or —CR⁴═CH₂,
where R³ represents an alkylene group an alkylidene group, or a —OCO— group, and R⁴ represents hydrogen or an alkyl group; in a molecule, and capable of undergoing radical copolymerization with the silicone resin at a weight ratio of 10:90 to 80:20.

2. A silica-containing silicone resin composition according to claim 1, wherein the silicone resin, which is prepared by subjecting a silicone compound represented by the general formula (3)
RSiX₃ (3)
where R is an organic functional group containing a (meth)acryloyl group and X represents a hydrolyzable group; to hydrolysis and partial condensation in the presence of a polar solvent and a basic catalyst, and further by subjecting the obtained hydrolysis product to recondensation in the presence of a nonpolar solvent and a basic catalyst, contains the same number of silicone atoms and (meth)acryloyl groups in the molecule and has a cage type structure.

3. A silica-containing silicone resin composition according to claim 1 or 2, wherein the unsaturated compound which is capable of undergoing radical copolymerization includes an unsaturated compound having a hydroxyl group represented by the general formula (4): 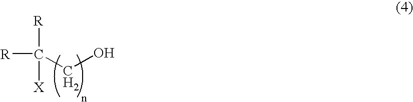
where R is an organic functional group containing a (meth)acryloyl group, X represents an organic functional group containing hydrogen or (meth)acryloyl group, and n is an integer of 0 or 1.

4. A silica-containing silicone resin composition according to claim 1, wherein the silica fine particle is treated with a silane compound of 0.1 to 80 wt %.

5. A silica-containing silicone resin composition according to claim 4, wherein the silane compound is represented by the general formula (5):
RₘSiAₙX₄₋ₘ₋ₙ (5)
where R is an organic functional group containing a (meth)acryloyl group, A is an alkyl group, X is an alkoxyl group or a halogen atom, m and n satisfy an integer in which m+n is 1 to 3, m is an integer of 0 or 1, and n is an integer of 0 to 3.

6. A silica-containing silicone resin copolymer, which is obtained by subjecting the silica-containing silicone resin composition according to claim 1 to radical copolymerization.

7. A resin molded article, which is obtained by subjecting the silica-containing silicone resin composition according to claim 1 to radical copolymerization.

8. A resin molded article according to claim 7, wherein the resin molded article comprises a coefficient of linear expansion of 40 ppm/K or less, a total light transmittance of 85% or more, and a glass transition temperature of 300° C. or more.

9. A method of producing a resin molded article, comprising subjecting the silica-containing silicone resin composition according to claim 1 to radical copolymerization by heating or irradiation with energy rays.
